(19) United States
(12) Patent Application Publication
(10) Pub. No.: US 2024/0262469 A1
(43) Pub. Date: Aug. 8, 2024

(54) RENEWABLE ENERGY SYSTEM MOUNTING APPARATUS AND BUOYANT PLATFORM

(71) Applicant: Marine Power Systems Limited, Swansea South Wales (GB)

(72) Inventor: Graham FOSTER, Swansea South Wales (GB)

(73) Assignee: Marine Power Systems Limited, Swansea South Wales (GB)

(21) Appl. No.: 18/637,137

(22) Filed: Apr. 16, 2024

Related U.S. Application Data
(63) Continuation of application No. PCT/EP2022/081165, filed on Nov. 8, 2022.

(30) Foreign Application Priority Data
Nov. 8, 2021 (GB) 2116002.3

(51) Int. Cl. B63B 39/00; B63B 21/50; B63B 35/44

(52) U.S. Cl. CPC B63B 39/00; B63B 21/50; B63B 35/44; B63B 2035/446

(57) ABSTRACT

A wind turbine mounting apparatus having a first non-yawing section; and a second yawing section affixed to a first end of the first section by a yawing mechanism, the yawing mechanism permits rotation of the second section relative to the first section about a yaw axis. The second section comprises at least two wind turbines, each of which have a rotor arranged to rotate about a rotor axis, the rotor axis defining a hub height and a plurality of blades affixed to the rotor. The rotation of the blades defines a swept area of the blades. The first section includes a first section width. The first section width is smaller at the first end than at a second end distal to the first end. The present invention provides a mounting solution for mounting multiple wind turbines to maximise energy captured per installation, while overcoming issues presented by mounting multiple turbines.

### CROSS REFERENCE TO RELATED APPLICATIONS

This continuation application claims priority benefit from International Application No. PCT/EP2022/081165 filed on Nov. 8, 2022, entitled Renewable Energy System Mounting Apparatus and Buoyant Platform, which claimed priority from Great Britain Application No. 2116002.3 filed on Nov. 8, 2021, both of which are incorporated herein by reference in their entireties.

### FIELD OF THE INVENTION

The present invention relates to a mounting platform for supporting a plurality of wind turbines, and also to a buoyant offshore renewable energy system mounting platform for mounting said apparatus.

### BACKGROUND TO THE INVENTION

The world is transitioning to renewable energy—this transition will require the exploitation of all forms or renewable energy to provide the planet with energy it needs.

One potential renewable energy source is wave power—an abundant and consistent energy resource available in all the world's large oceans and seas. Another is wind power, with wind speeds being higher and more consistent over oceans and seas compared to land.

For these reasons, offshore platforms providing means to mount renewable energy devices which harness wave and/or wind power in deep water are required. Resource requirements for installing said platforms are suboptimal however, relative to energy output per corresponding installation. For example, time and cost for anchors, moorings, installation & electrical connections for each installation is in need of improvement in order to encourage mass adoption.

The resource requirement for platform installation directly influences the energy, and cost thereof, produced by the installations. Therefore, there is a need for the resource requirement and cost per installation to be as optimised as possible relative to energy output by renewable energy devices mounted on the respective platforms.

### SUMMARY OF THE INVENTION

The present disclosure is directed to a wind turbine mounting apparatus for mounting two or more wind turbines to a single support structure, the wind turbines arranged to yaw about a yaw axis in accordance with a prevailing wind direction. In particular the disclosure provides a first non-yawing section and a second yawing section mounted thereto, the second yawing section comprising the at two or more wind turbines. The first non-yawing section comprises a width thereof which is narrower at a first end proximate the yawing section and wider at a second end distal to the yawing section. Such a structure is preferably robust to bending moments exerted by the thrust and mass of the wind turbines in operation.

In accordance with a first aspect of the present invention therefore, there is provided a wind turbine mounting apparatus for mounting two or more wind turbines to a base, the apparatus comprising: a first non-yawing section; and a second yawing section affixed to a first end of the first section by a yawing mechanism, the yawing mechanism arranged to permit rotation of the second section relative to the first section about a yaw axis; wherein the second section comprises at least two wind turbines, each of the at least two wind turbines having: a rotor arranged to rotate about a rotor axis, the rotor axis defining a hub height of the wind turbine; and a plurality of blades affixed to the rotor, wherein rotation of said blades in use defines a swept area of said blades; and wherein the first section comprises a first section width, wherein the first section width is smaller at the first end thereof than at a second end distal to the first end.

In use the yawing mechanism is arranged to permit rotation of the second section about the yaw axis such that the at least two wind turbines are positioned with a wind capturing surface thereof opposing a prevailing wind direction. As such the apparatus is arranged to capture wind energy irrespective of the prevailing wind direction. The wind turbines will be understood to comprise, or be in communication with, an energy converter arranged to convert the captured wind energy to useful energy. Said useful energy may be stored on or proximate the apparatus by way of an energy storage member, and/or transported from the apparatus by way of an energy transmission member.

The term “swept area” will be understood by the skilled addressee within the context of the present invention to mean an area defined by the turbine blades during rotation about the rotor axis. The swept area will therefore be understood to be substantially circular, comprising a radius extending from the rotor axis to an outermost edge of the swept area. In preferable embodiments, the yawing mechanism is positioned at a yawing mechanism height, the yawing mechanism height being located above a lowermost edge of the swept area of said blades in use. A position of the yawing mechanism height above a lowermost edge of the swept area, preferably experiences a lower bending moment from thrust and mass of the turbines and as such provides a stable positioning of the yawing mechanism in use. The yawing mechanism height will be understood by the skilled addressee in the present context to refer to a horizontal plane in space occupied any part of the yawing mechanism. In some preferable embodiments, the yawing mechanism height is positioned substantially at the hub height. A position of the yawing mechanism at the hub height preferably experiences the lowest bending moment from thrust and mass of the turbines and as such provides an optimally stable yawing mechanism position. Placing the yawing mechanism height below the hub height, but above the lowermost point of the swept area may in some embodiments serve as a compromise in minimising bending moment from thrust and mass of the turbines while also minimising overall height of the apparatus.

The second section preferably comprises a second section centre of gravity, and in preferable embodiments the yawing mechanism is positioned such that the yaw axis is coaxially aligned with the second section centre of gravity. The second section centre of gravity will be understood to be a combined centre of gravity of all components of the second section, including the two or more wind turbines and the yawing mechanism, along with any structural elements connecting the two or more wind turbines to the yawing mechanism. The term “coaxially aligned” may refer in the same context to an alignment on a horizontal and/or vertical plane in use. Having the centre of gravity of the second section coaxially aligned with the yaw axis preferably provides optimal weight distribution and therefore optimal stability of yawing, or rotation of the second section about the yaw axis by way of the yawing mechanism.

In preferable embodiments, the second section comprises an elongate structural member extending between proximate the yawing mechanism and a surface of the corresponding wind turbine, the elongate structural member defining a distance between the rotor axis of the corresponding wind turbine and the yaw axis. The rotor axis of each of the at least two wind turbines is preferably located equidistant from the yaw axis. The positioning of each of the wind turbines equidistant from the yaw axis preferably distributes the weight thereof evenly about the yaw axis to provide optimum stability to the yaw mechanism.

In some preferable embodiments, the second section comprises an elongate structural member extending between proximate the yawing mechanism and a surface of the corresponding wind turbine. The elongate structural member preferably extends substantially perpendicular to the yaw axis.

In some preferable embodiments, the second section comprises a plurality of elongate structural members affixing yawing mechanism to a corresponding wind turbine, and any suitable such structure will be envisaged. The elongate structural members preferably provide a skeletal frame arranged to provide minimal resistance to wind forces. In some particular embodiments, the plurality of elongate structural members of the second section are positioned to structurally triangulate the corresponding wind turbine, thereby preferably providing maximum stability of the wind turbine in use.

In some preferable embodiments, the second section comprises: a first elongate structural member having a first end thereof in communication with a first position located along the yaw axis and in a first plane coplanar with the yaw axis, and a second end thereof distal to the first end in communication with a surface of the corresponding wind turbine; and a second elongate structural member having a first end thereof in communication with a second position different to the first position, and a second end thereof distal to the first end in communication with a surface of said corresponding wind turbine, the second position being located in the first plane coplanar with the first position and in a second plane perpendicular to the first plane, the second plane located at, above or below the first position. In preferable embodiments, the second position is located in the first plane behind the first position. In some embodiments it will be appreciated that the second position may instead be located along the yaw axis. The second end of the first and/or second elongate structural member may be directly affixed to a surface of the corresponding wind turbine. In some embodiments wherein the second end of the first elongate structural member is affixed to a surface of the corresponding wind turbine, the second end of the second elongate structural member may be affixed to the first elongate structural member proximate the second end thereof. In preferable embodiments, the first elongate structural member and the second elongate structural member preferably act to structurally triangulate the corresponding wind turbine, thereby maximising structural stability of the wind turbine in use. In preferable such embodiments, the first elongate structural member or the second elongate structural member may extend substantially perpendicular to the yaw axis.

In embodiments comprising said first and second elongate structural members, the first position is preferably at, or proximate, the yawing mechanism. In embodiments wherein the second position is in the second plane above the first position, the second section preferably further comprises a third elongate structural member extending (preferably in a vertical direction) from the yawing mechanism and arranged to yaw therewith relative to the first section, the second position located along the third elongate structural member. In embodiments wherein the second position is below the first position, the first section preferably further comprises a non-yawing vertical elongate structural member extending in a vertical direction from the first section. In such embodiments the yawing mechanism is located at the first position along the non-yawing vertical elongate structural member, permitting yawing of the second section relative thereto. In such embodiments, the second elongate structural member is rotationally affixed to the non-yawing vertical elongate structural member at the second position, such as by way of a rotational bearing. In some such embodiments, at least one of the yawing mechanism and the rotational bearing may preferably be supported upon a corresponding flange of the non-yawing vertical elongate structural member, such that the weight of the second section is at least in part supported thereby and structural triangulation of the corresponding wind turbine is facilitated. In preferable such embodiments, the yawing mechanism is positioned atop the non-yawing vertical elongate structural member. The term “extending in a vertical direction” will be understood by the skilled addressee to mean extending in a direction at least partially defined by a positive (upwards) or negative (downwards) vertical component, and therefore not completely horizontal.

Features described herein referring to “the elongate structural member” will be understood as being suitable for application to the first and/or second elongate structural members in embodiments comprising a plurality of said elongate structural members.

The distance between the rotor axis of the corresponding wind turbine and the yaw axis is preferably equal to or greater than a radius of the swept area. In such embodiments, the blades of the two or more turbines may occupy the same plane as the first section without impacting the first section. Yawing of the wind turbines about the yaw axis may optionally therefore occur freely throughout a 360° rotational path without the blades of the wind turbines impacting the first section. In combination with the width differential in the first section at opposing ends thereof, a first section optimised to withstand bending moments from thrust and mass of the wind turbines is able to be provided.

In some embodiments, the elongate structural member is substantially tubular or cylindrical in shape. The elongate structural member preferably comprises a streamlined shape. The term “streamlined” will be understood within the context of the present invention as a common term of the art. The elongate structural member therefore preferably comprises a maximal height and a depth along a longitudinal axis thereof, the depth being greater than the maximal height. The term “maximal height” will be understood to refer equally to structures having a continuous height across a depth thereof, or a variable height across a depth thereof. The elongate structural member is therefore preferably aerodynamic/streamlined. The elongate structural member may preferably have a substantially oval or aerofoil/airfoil cross section. In such embodiments, a leading edge may be considered to be one that has a lower than maximal height. The term “leading edge” will be understood in the context of the present invention as a foremost edge of the elongate structural member positioned to be the first to meet oncoming wind/air. An aerodynamic/streamlined shape therefore preferably reduces wind resistance and therefore improves efficiency of the wind turbines.

The first section preferably comprises a plurality of elongate structural members extending from proximate the yawing mechanism at the first end thereof to the second end of the first section. The plurality of elongate structural members preferably define outer edges of the first section, said edges therefore defining said width of the first section. The plurality of structural elements preferably form a foraminous or skeletal frame structure such that aerodynamic or hydrodynamic drag is minimised in use.

The plurality of elongate structural members of the first section preferably form upstanding edges of a substantially pyramidal or tetrahedral structure of the first section, the first end of the first section forming an apex of said substantially pyramidal or tetrahedral structure. A pyramidal or tetrahedral structure is preferably an efficient mode of transmitting the thrust and mass forces from the turbines through the structure without creating unnecessary bending moments in the non-yawing first section.

In preferable embodiments, at least three said elongate structural members of the first section extend from proximate the yawing mechanism of the second section to provide a triangulated second section. The support of the yawing mechanism by the structural members of the first section is therefore preferably such that the yawing mechanism is triangulated by the said structural members. The term “triangulated” will be understood within the context of the present invention as using structural triangulation, such as for example beam triangulation, to support the second section. Such triangulation preferably maximises the robustness of said support against external forces acting thereon.

In preferable embodiments, elongate structural members of the second section that experience compressive forces in use are rigid braces and the elongate structural members that experience only tensile forces in use are tendons.

The two or more wind turbines may be any combination of suitable wind turbines. In preferable embodiments, the at least two turbines comprise: downwind wind turbines and/or upwind turbines. In some preferable embodiments, the wind turbines are the same.

Said rotation of the yawing mechanism about the yaw axis is preferably arranged to be driven by a motor, preferably in response to a control input indicating a prevailing wind direction and/or a corresponding target yaw angle. The control input may be received by the motor from an onboard prevailing wind direction sensing system, or may be received from a remote source, such as a farm sensing system comprising a single sensing system arranged to detect a prevailing wind direction local to a farm of multiple said apparatuses, and subsequently output the control signal to said multiple apparatus for receipt by the onboard motor. In preferable embodiments thereof, said rotation is only arranged to be driven by said motor, and unless driven by said motor the second section is therefore maintained substantially stationary.

In some embodiments, the apparatus may further comprise a prevailing wind direction sensor arranged to detect a prevailing wind direction. In such embodiments comprising a motor, the motor may be arranged to drive said rotation of the yawing mechanism based on the detected prevailing wind direction, such that a wind engaging surface of the wind turbines is positioned to oppose the oncoming prevailing wind in said direction.

In some embodiments, the yawing mechanism may be arranged to permit yawing of the second section about the yaw axis passively. In some such embodiments, the yawing mechanism may also comprise said motor for combined passive and motorised yawing in use.

In accordance with a second aspect of the present invention, there is provided an offshore renewable energy system mounting platform for positioning two or more wind turbines in a body of water, the platform comprising: a mounting apparatus in accordance with the first aspect; a buoyant base member having a buoyancy in the body of water, the mounting apparatus positioned on the buoyant base member; and
a plurality of mooring lines arranged to tether the buoyant base member to a bed of the body of water.

The second aspect therefore permits use of the mounting apparatus of the first aspect on an offshore marine platform.

The base member preferably comprises at least one buoyant body, the at least one buoyant body defining a centre of buoyancy of the base. In some embodiments, the base member may comprise a plurality of said buoyant bodies, each said buoyant body being positioned on the base equidistant from said centre of buoyancy of the base. In some embodiments, the centre of buoyancy of the base may be coaxially aligned with the yaw axis. Such embodiments may confer maximum stability to the base in use. In some embodiments experiencing variable bending moments due to the thrust and mass of the turbines, a buoyancy of the one or more buoyancy members may be adjustable in order to accommodate the variable bending moments. Such variable buoyancy may, for example, dynamically shift the centre of buoyancy in accordance with the bending moments, and thereby may confer maximal stability on the platform in use.

The plurality of mooring lines preferably extend from the base to corresponding anchor points located on the bed of the body of water, said corresponding anchor points each located equidistant from a central mooring axis coaxially aligned with the yaw axis. Such a mooring configuration preferably stabilises the platform against variable wind and wave forces in various directions.

The platform preferably further comprises a depth-setting member arranged to adjust a length of the plurality of mooring lines to define a depth of the platform in the body of water.

The platform preferably comprises a submerged operating mode, wherein at least a portion of the first section is submerged in the body of water by the depth setting means. In the submerged operating mode, the wind turbines are arranged to capture wind energy. In most preferable embodiments of the submerged operating mode, the yawing mechanism is not submerged.

In some embodiments of the second aspect, additional components may include boat landings, ladders and mooring equipment, among others.

It will be appreciated that the buoyant base member may form the first section of the mounting apparatus.

It will be further appreciated that any features described herein as being suitable for incorporation into one or more aspects or embodiments of the present disclosure are intended to be generalizable across any and all aspects and embodiments of the disclosure.

### BRIEF DESCRIPTION OF THE DRAWINGS

The accompanying figures, which are incorporated herein and constitute a part of the specification, illustrate embodiments of the disclosure and together with the detailed description herein, serve to explain the principles of the disclosure. The figures are only for purposes of illustrating preferred embodiments and are not to be construed as limiting the disclosure:

FIG. 1 depicts a perspective view of an example embodiment of a platform in accordance with the second aspect, comprising an example mounting apparatus of the first aspect, in accordance with an aspect of the present disclosure;

FIG. 2 depicts a front view of a further example embodiment similar to that shown in FIG. 1, in accordance with an aspect of the present disclosure;

FIG. 3 shows a front view of an alternate example embodiment to that shown in FIG. 2, in accordance with an aspect of the present disclosure;

FIG. 4 depicts a plan view of the platform of FIG. 3 in a first yaw position, in accordance with an aspect of the present disclosure;

FIG. 5 depicts a plan view of the platform of FIG. 3 in a second yaw position, in accordance with an aspect of the present disclosure; and

FIG. 6 shows a front view of an alternate example embodiment to that shown in FIG. 2 and FIG. 3, in accordance with an aspect of the present disclosure.

### DETAILED DESCRIPTION FOR CARRYING OUT THE INVENTION

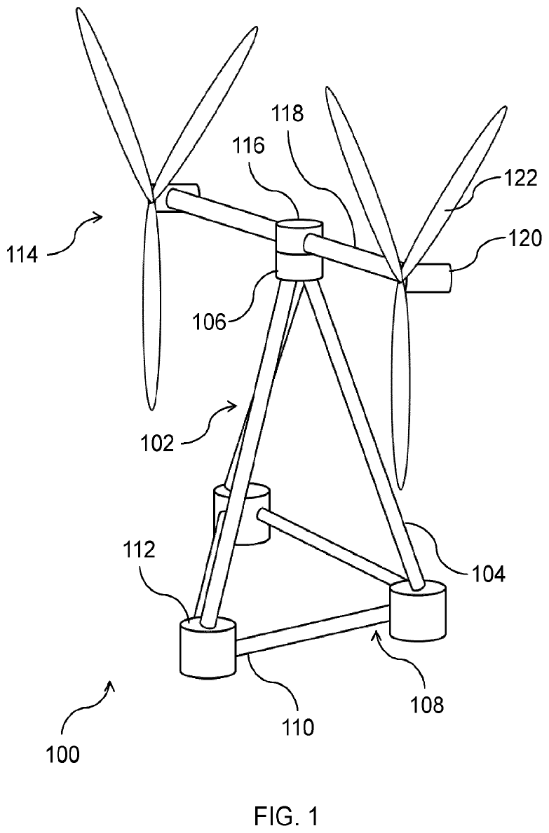

Referring to FIG. 1 a perspective view is shown of an example embodiment 100 of a platform in accordance with the second aspect, comprising an example mounting apparatus of the first aspect. The apparatus comprises a substantially pyramidal first section 102 having three elongate structural beams 104 extending from an apex 106 of the pyramid toward corresponding vertices of a triangular base member 108 of the platform 100. The three structural beams 104 therefore form the upstanding edges of the pyramid and provide triangulated support to the apex 106 of the pyramidal structure. Each of the vertices of the triangular base member 108 is connected to another of said vertices by an elongate structural base beam 110. Positioned at each of the vertices of the triangular base member 108 is a corresponding buoyant body 112 having a buoyancy in a body of water.

Supported atop the apex 106 of the pyramidal first section 102 is a second yawing section 114 having a yawing mechanism 116 affixed adjacent the apex 106 of the first section 102 and arranged to permit rotation of the second section 114 relative to the first section 102 about a yaw axis. Extending in opposite directions from adjacent the yawing mechanism 116 are a pair of opposing structural beams 118, each affixed to a corresponding nacelle 120 of a wind turbine at an end thereof distal to the yawing mechanism 116. The nacelles 120 each house a rotor (not shown) arranged to permit rotation of the blades 122 of the wind turbines about a rotor axis, the rotor axis substantially perpendicular to the yaw axis in the example shown. Said rotation of the blades 122 defines a circular swept area of the blades in use, the swept area having a radius extending from the rotor axis to the tip of one of the blades 122. The second section structural beams 118 in the embodiment shown define a distance of the rotor axis from the yawing mechanism 116 of greater than the swept area radius. In the example embodiment shown, the second section structural beams 118 are of equal length so as to equally distribute the forces exerted upon the platform 100 by the wind turbines. The rotor axis of the wind turbines defines a hub height of the respective wind turbine. In the embodiment 100 shown, the hub height of each wind turbine is identical. The yawing mechanism 116 in the embodiment shown is positioned at the hub height, such that the bend moments from the thrust and mass of the wind turbines exhibited by the platform 100 are minimised. This reduction of bending moment preferably acts to reduce unwanted forces acting on the yawing mechanism, to the benefit of component sizing, and wear and tear on the platform components.

The yawing mechanism 116 in the embodiment shown comprises a motor (not shown) arranged to drive the rotation of the second section 114 about the yaw axis, in accordance with a prevailing wind direction in use. The distance of the rotor axis from the yawing mechanism 116 ensures that the second section 114 can rotate freely without the blades 122 of the wind turbines impacting the pyramidal first section 102.

The pyramidal structure shown is preferably an efficient way to transmit the thrust and mass forces from the turbines through the structure without creating unnecessary bending moments in the non-yawing first section of the platform. Structural beams of the second section experiencing compressive forces are preferably rigid beams, and structural beams experiencing only tensile forces are preferably tendons.

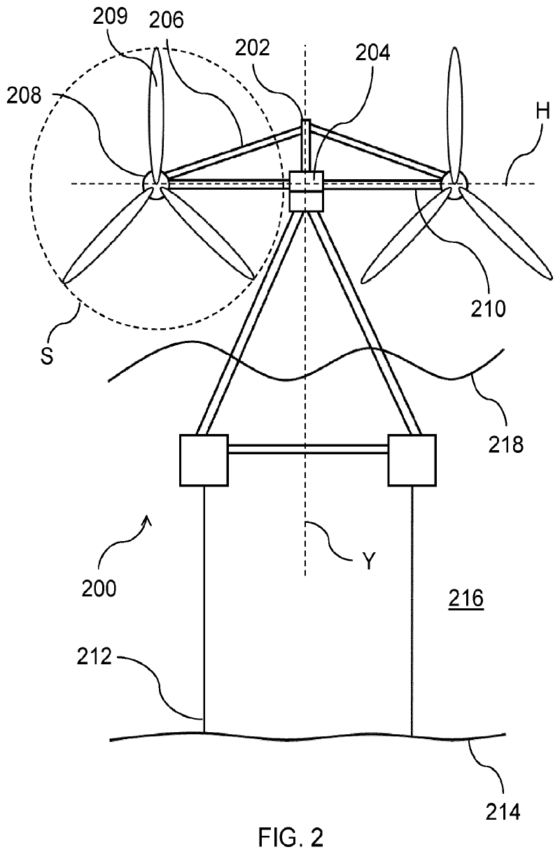

Referring to FIG. 2, an example embodiment 200 of a platform in accordance with the second aspect of the present invention is shown in front view, comprising a mounting apparatus of the first aspect. The embodiment 200 is substantially the same as the embodiment 100 of FIG. 1, but having an arrangement of additional second section support beams, comprising a central support beam 202 extending upwards from adjacent the yawing mechanism 204 and away from the viewer of FIG. 2. The additional second section support beam arrangement further comprises two elongate beams 206 extending between an end of the central beam 202 distal to the yawing mechanism 204 and a corresponding nacelle 208 of a wind turbine. As described, the nacelles 208 each house a rotor (not shown) arranged to permit rotation of the blades 209 of the wind turbines about a rotor axis, the rotor axis substantially perpendicular to the yaw axis Y in the example shown. Said rotation of the blades 209 defines a circular swept area S of the blades in use, the swept area having a radius extending from the rotor axis to the tip of one of the blades 209. Together with the previously described second section support beams 210, the second section support beam arrangement provides triangulated support for each of the wind turbines.

In the embodiment 200 shown, as with the embodiment 100 of FIG. 1 the rotor axis of each wind turbine defines the hub height H thereof, which is the same as the height of the yawing mechanism 204.

Not shown in FIG. 1, the platform 200 further comprises a plurality of mooring lines 212 extending from adjacent the base member and tethering the platform 200 to a bed 214 of a body of water 216. The embodiment 200 is shown in a submerged operating mode, with the base of the platform 200 and a portion of the first section thereof submerged beneath a surface 218 of the body of water 216, by spooling the mooring lines 212 using corresponding motorised winches (not shown). Any suitable depth-setting mechanism will be appreciated. In the submerged operating mode shown, the buoyancy of the platform base acts to counteract the effects of gravity on the platform 200 components, which together with the mooring arrangement, provide stability of the platform 200 in use. The combined components of the yawing section of the platform 200 comprise a centre of gravity which is collocated with the yaw axis Y in the embodiment shown, which further confers stability upon the platform in use.

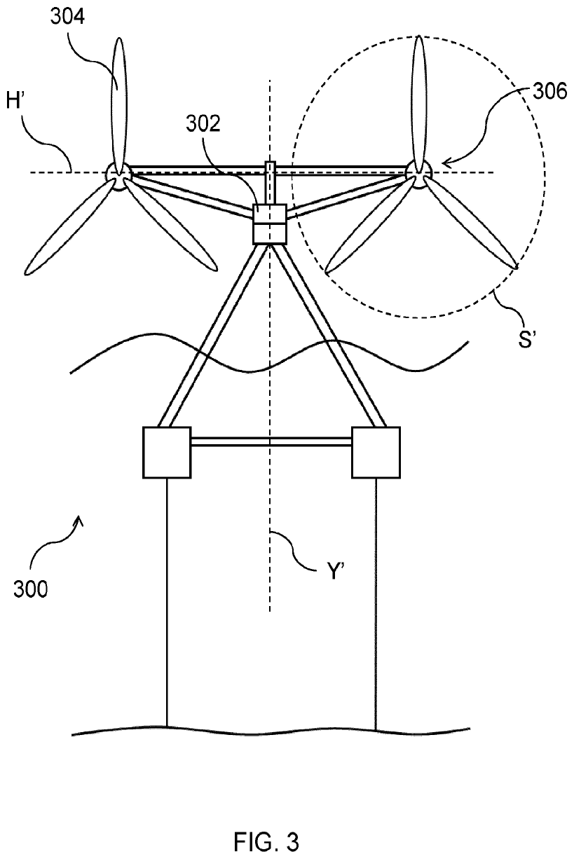

Referring to FIG. 3, a platform 300 is shown having substantially the same configuration as the platform 200 of FIG. 2, but having the yawing mechanism 302 thereof positioned below the hub height H′, but above a lowermost point of the swept area S′ of the blades 304 of the wind turbines 306. The overall height of the platform is therefore reduced compared to the configuration 200 of FIG. 2, while maintaining robustness to bend moments experienced due to thrust and mass from the wind turbines 306.

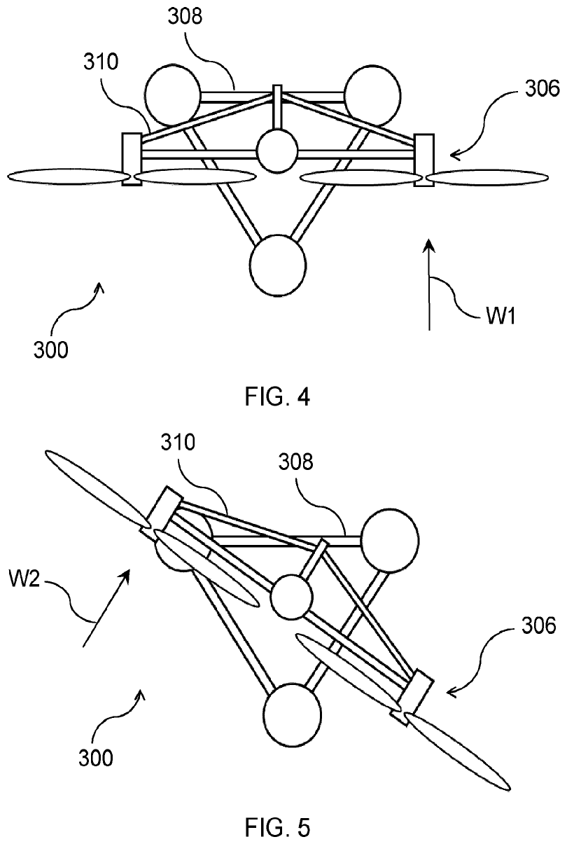

Referring to FIG. 4, a plan view of the embodiment 300 of FIG. 3 is shown having the second section 308 positioned in a first yaw position relative to the first section 310. Such a position is achieved by a motor (not shown) arranged to drive rotation of the second section 308 about a yaw axis Y′ of the second section defined by the yaw mechanism. The first yaw position shown positions the wind engaging surface of the wind turbines 306 to engage the wind in a prevailing wind direction W1, in order to capture wind energy therefrom.

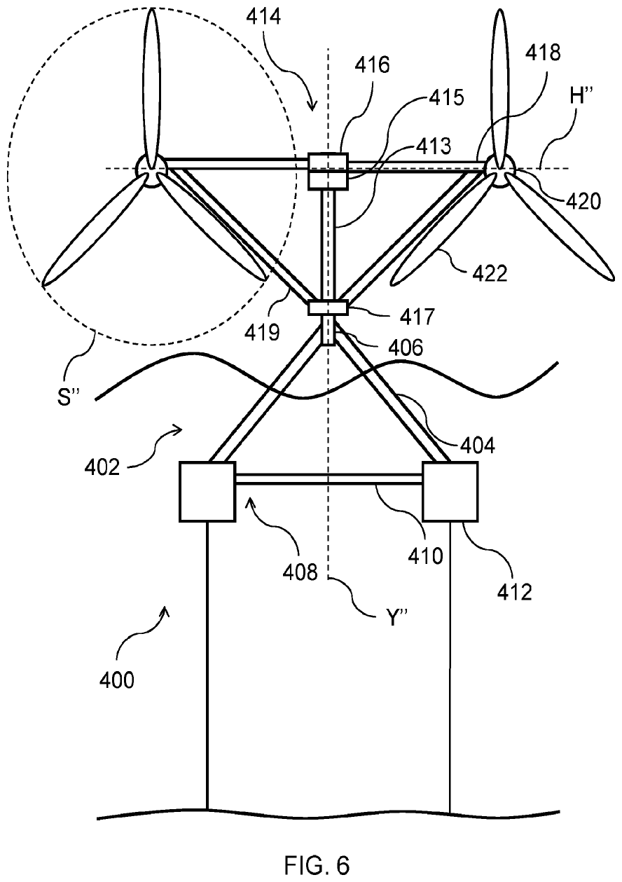

Referring to FIG. 5, a plan view of the embodiment 300 of FIG. 4 is shown, wherein an alternate prevailing wind direction W2 has caused the motor (not shown) to drive the rotation of the second section 308 to achieve a second yaw position shown. In the second yaw position shown, the wind engaging surface of the wind turbines 306 are positioned to engage the wind in a prevailing wind direction W2, in order to capture wind energy therefrom.

Referring to FIG. 6 a front view of a further embodiment 400 is shown of a platform in accordance with the second aspect comprising a mounting apparatus of the first aspect. In the further example 400 shown, the apparatus is shown comprising a substantially pyramidal first section 402 having three elongate structural beams 404 extending from an apex 406 of the pyramid toward corresponding vertices of a triangular base member 408 of the platform 400. The three structural beams 404 therefore form the upstanding edges of the pyramid and provide triangulated support to the apex 406 of the pyramidal structure. Each of the vertices of the triangular base member 408 is connected to another of said vertices by an elongate structural base beam 410. Positioned at each of the vertices of the triangular base member 408 is a corresponding buoyant body 412 having a buoyancy in a body of water.

Extending from atop the apex 406 of the pyramid, the first section 402 further comprises a vertically extending structural beam 413. Affixed to the vertically extending structural beam 413 of the first section 402, is a second yawing section 414 having a yawing mechanism 416 affixed adjacent the top 415 of the vertically extending structural beam 413 and arranged to permit rotation of the second section 414 relative to the first section 402 about a yaw axis Y″. Extending in opposite directions from adjacent the yawing mechanism 416 are a pair of opposing first structural beams 418, each affixed to a corresponding nacelle 420 of a wind turbine at an end thereof distal to the yawing mechanism 416. The nacelles 420 each house a rotor (not shown) arranged to permit rotation of the blades 422 of the wind turbines about a rotor axis, the rotor axis (extending directly outwards from the page in the front view shown) being substantially perpendicular to the yaw axis Y″ in the example shown. Said rotation of the blades 422 defines a circular swept area S″ of the blades in use, the swept area having a radius extending from the rotor axis to the tip of one of the blades 422. The first structural beams 418 of the second section in the embodiment shown define a distance of the rotor axis from the yawing mechanism 416 of greater than the swept area radius. In the example embodiment shown, the first structural beams 418 of the second section are of equal length so as to equally distribute the forces exerted upon the platform 400 by the wind turbines. The rotor axis of the wind turbines defines a hub height H″ of the respective wind turbine. In the embodiment 400 shown, the hub height of each wind turbine is identical. The yawing mechanism 416 in the embodiment shown is positioned at the hub height, such that the bend moments from the thrust and mass of the wind turbines exhibited by the platform 400 are minimised. This reduction of bending moment preferably acts to reduce unwanted forces acting on the yawing mechanism, to the benefit of component sizing, and wear and tear on the platform components.

The yawing mechanism 416 in the embodiment shown comprises a motor (not shown) arranged to drive the rotation of the second section 414 about the yaw axis, in accordance with a prevailing wind direction in use. The distance of the rotor axis from the yawing mechanism 416 ensures that the second section 414 can rotate freely without the blades 422 of the wind turbines impacting the pyramidal first section 402.

In the embodiment 400 shown, the second section further comprises a pair of second structural beams 419, each extending from a respective location on a corresponding first structural beam proximate a respective wind turbine, in a downward direction toward a position on the vertically extending structural beam 413. Each of the pair of second structural beams 419 is in rotational communication with the vertically extending structural beam 413 at the position by way of a rotational bearing 417, thereby acting to provide additional support for the weight of the respective turbine. Each of the pair of second structural beams 419 thereby, together with the respective first structural beams 418, acts to structurally triangulate the respective wind turbine to provide stability in use.

In any embodiment of the present disclosure, a preferable pyramidal structure as shown is preferably an efficient way to transmit the thrust and mass forces from the turbines through the structure without creating unnecessary bending moments in the non-yawing first section of the platform. Structural beams of the second section experiencing compressive forces (for example the downward extending second structural beams) are preferably rigid beams, and structural beams experiencing only tensile forces (for example the first structural beams) are preferably tendons and may in some embodiments have different elastic properties to the those of the rigid beams, for example to be more flexible or elastic than the rigid beams.

Further embodiments within the scope of the present disclosure may be envisaged that have not been described above, for example, the first section in the examples shown is a pyramidal structure. Any suitable structure may be envisaged wherein the first and second ends thereof comprise a different width for supporting the bending moments exerted by the multiple wind turbines. The base member of the platform is shown as a triangular base having buoyant bodies affixed thereto. Embodiments will be appreciated wherein the base member is any suitable base for the first section, such as a barge or semi-sub system. Embodiments will also be appreciated wherein, in place of the buoyant bodies shown, the structural elements of the base member themselves comprise a buoyancy. The motor in the embodiments shown may be manually driven, but embodiments will also be appreciated wherein the apparatus comprises a prevailing wind direction sensor, the prevailing wind direction detected by said sensor being used to determine a yaw angle to be achieved by the motor, for automatic yawing. Embodiments will also be appreciated wherein said yawing is performed passively. Because the yawing section of the platform is always orientated to the wind, the wind direction through the structural members of the yawing section is known, therefore, the structural members of the yawing section can be streamlined to reduce aerodynamic drag and turbulence which can interference with the wind turbines. This permits the turbines to be either of an upwind design as shown in the depicted embodiments, or of a downwind design. Embodiments will therefore be appreciated wherein the second section support beams are aerodynamic/streamlined in order to reduce the effects of wind resistance on the second section. As such the second section support beams may comprise a substantially oval or aerofoil/airfoil cross section, or any suitable shape having a leading edge which is shorter than a maximal cross-sectional height of the support beam, with the leading edge facing the same direction as the wind turbines. The structure of the apparatus shown comprises structural beams, but any suitable structural member will be appreciated.

As may be recognized by those of ordinary skill in the art based on the teachings herein, numerous changes and modifications may be made to the above-described and other embodiments of the present disclosure without departing from the scope of the disclosure. The components of the mounting platform as disclosed in the specification, including the accompanying abstract and drawings, may be replaced by alternative component(s) or feature(s), such as those disclosed in another embodiment, which serve the same, equivalent or similar purpose as known by those skilled in the art to achieve the same, equivalent or similar results by such alternative component(s) or feature(s) to provide a similar function for the intended purpose. In addition, the implants may include more or fewer components or features than the embodiments as described and illustrated herein. Accordingly, this detailed description of the currently-preferred embodiments is to be taken in an illustrative, as opposed to limiting the disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The disclosure has been described with reference to the preferred embodiments. It will be understood that the architectural and operational embodiments described herein are exemplary of a plurality of possible arrangements to provide the same general features, characteristics, and general system operation. Modifications and alterations will occur to others upon a reading and understanding of the preceding detailed description. It is intended that the disclosure be construed as including all such modifications and alterations.

What is claimed is:

1. A wind turbine mounting apparatus, the apparatus comprising:
a first non-yawing section; and
a second yawing section affixed to a first end of the first section by a yawing mechanism, the yawing mechanism arranged to permit rotation of the second section relative to the first section about a yaw axis;
wherein the second section comprises at least two wind turbines, each of the at least two wind turbines having:
a rotor arranged to rotate about a rotor axis, the rotor axis defining a hub height of the wind turbine; and
a plurality of blades affixed to the rotor, wherein rotation of said blades in use defines a swept area of said blades; and
wherein the first section comprises a first section width, wherein the first section width is smaller at the first end thereof than at a second end distal to the first end.

2. The mounting apparatus of claim 1, wherein the yawing mechanism is positioned at a yawing mechanism height, the yawing mechanism height being located above a lowermost edge of the swept area of said blades in use.

3. The mounting apparatus of claim 2, wherein the yawing mechanism height is located substantially at the hub height.

4. The mounting apparatus of claim 1, wherein the second section comprises a second section centre of gravity, and wherein the yawing mechanism is positioned such that the yaw axis is coaxially aligned with the second section centre of gravity.

5. The mounting apparatus of claim 1, wherein the second section comprises an elongate structural member extending between proximate the yawing mechanism and a surface of the corresponding wind turbine, the elongate structural member defining a distance between the rotor axis of the corresponding wind turbine and the yaw axis.

6. The mounting apparatus of claim 5, wherein the rotor axis of each of the at least two wind turbines is located equidistant from the yaw axis.

7. The mounting apparatus of claim 5, wherein the distance between the rotor axis of the corresponding wind turbine and the yaw axis is equal to or greater than a radius of the swept area.

8. The mounting apparatus of claim 5, wherein the elongate structural member comprises a streamlined shape.

9. The mounting apparatus of claim 1, wherein the first section comprises a plurality of elongate structural members extending from proximate the yawing mechanism at first end thereof to the second end of the first section.

10. The mounting apparatus of claim 9, wherein the plurality of elongate structural members of the first section form the upstanding edges of a substantially pyramidal structure of the first section, the first end of the first section forming an apex of said substantially pyramidal structure.

11. The mounting apparatus of claim 10, wherein at least three said elongate structural members of the first section extend from proximate the yawing mechanism of the second section to provide a triangulated second section.

12. The mounting apparatus of claim 9, wherein the elongate structural members that experience only tensile forces are tendons.

13. The mounting apparatus of claim 1, wherein the at least two turbines comprise: downwind wind turbines and/or upwind turbines.

14. The mounting apparatus of claim 1, wherein said rotation of the yawing mechanism about the yaw axis is arranged to be driven by a motor in response to control input indicating a prevailing wind direction.

15. The mounting apparatus of claim 1, wherein the yawing mechanism is arranged to permit yawing of the second section about the yaw axis passively.

16. An offshore renewable energy system mounting platform for positioning two or more wind turbines in a body of water, the platform comprising:
a mounting apparatus;
a buoyant base member having a buoyancy in the body of water, the mounting apparatus positioned on the buoyant base member; and
a plurality of mooring lines arranged to tether the buoyant base member to a bed of the body of water.

17. The platform of claim 16, wherein the base member comprises at least one buoyant body, the at least one buoyant body defining a centre of buoyancy of the base.

18. The platform of claim 17, wherein the base member comprises a plurality of said buoyant bodies, each said buoyant body being positioned on the base equidistant from said centre of buoyancy of the base.

19. The platform of claim 17, wherein the centre of buoyancy of the base is coaxially aligned with the yaw axis.

20. The platform of claim 16, wherein the plurality of mooring lines extend from the base to corresponding anchor points located on the bed of the body of water, said corresponding anchor points each located equidistant from a central mooring axis coaxially aligned with the yaw axis.

21. The platform of claim 16, wherein the buoyant base member forms the first section of the mounting apparatus.
